(19) United States
(12) Patent Application Publication
(10) Pub. No.: US 2020/0042872 A1
(43) Pub. Date: Feb. 6, 2020

(54) MODEL ESTIMATION DEVICE, MODEL ESTIMATION METHOD, AND MODEL ESTIMATION PROGRAM

(71) Applicant: NEC CORPORATION, Tokyo (JP)

(72) Inventors: Yusuke MURAOKA, Tokyo (JP); Ryohei FUJIMAKI, Tokyo (JP); Zhao SONG, Durham, NC (US)

(73) Assignee: NEC CORPORATION, Tokyo (JP)

(21) Appl. No.: 16/339,934

(22) PCT Filed: Aug. 16, 2017
(86) PCT No.: PCT/JP2017/029476

§ 371 Date: Apr. 5, 2019

(30) Foreign Application Priority Data
Oct. 7, 2016 (JP) 2016-199103

(51) Int. Cl. G06N 3/08; G06N 7/00; G06Q 10/06; G06F 17/18

(52) U.S. Cl. CPC G06N 3/08; G06F 17/18; G06Q 10/063; G06N 7/005

(57) ABSTRACT

A parameter estimation unit 81 estimates parameters of a neural network model that maximize the lower limit of a log marginal likelihood related to observation value data and hidden layer nodes. A variational probability estimation unit 82 estimates parameters of the variational probability of nodes that maximize the lower limit of the log marginal likelihood. A node deletion determination unit 83 determines nodes to be deleted on the basis of the variational probability of which the parameters have been estimated, and deletes nodes determined to correspond to the nodes to be deleted. A convergence determination unit 84 determines the convergence of the neural network model on the basis of the change in the variational probability.

### TECHNICAL FIELD

The present invention relates to a model estimation device, a model estimation method, and a model estimation program for estimating a model of a neural network.

### BACKGROUND ART

A model of a neural network is a model in which nodes existing in respective layers are connected to interact with each other to express a certain output v. FIG. 5 is an explanatory diagram illustrating a model of a neural network.

In FIG. 5, nodes z are represented by circles, and a set of nodes arranged in rows represents each layer. In addition, the lowermost layer v₁, . . . , and v_{M} indicate output (visible element), and an l layer above the lowermost layer (in FIG. 5, l=2) indicates a hidden layer having elements of the number of J₁. In the neural network, nodes and layers are used to define hidden variables.

Non Patent Literature 1 discloses an exemplary method of learning a neural network model. According to the method disclosed in Non Patent Literature 1, the number of layers and the number of nodes are determined in advance to perform learning of a model using the variational Bayesian estimation, thereby appropriately estimating parameters representing the model.

An exemplary method of estimating a mixed model is disclosed in Patent Literature 1. According to the method disclosed in Patent Literature 1, a variational probability of a hidden variable with respect to a random variable serving as a target of mixed model estimation of data is calculated. Then, using the calculated variational probability of the hidden variable, a type of a component and its parameter are optimized such that the lower limit of the model posterior probability separated for each component of the mixed model is maximized, thereby estimating an optimal mixed model.

### CITATION LIST

### Patent Literature

PTL 1: International Publication No. 2012/128207

### Non Patent Literature

NPL 1: D. P. and Welling, M., “Auto-encoding variational Bayes”, arXiv preprint arXiv: 1312.6114, 2013.

### SUMMARY OF INVENTION

### Technical Problem

Performance of the model of the neural network is known to depend on the number of nodes and the number of layers. When the model is estimated using the method disclosed in Non Patent Literature 1, it is necessary to determine the number of nodes and the number of layers in advance, whereby there has been a problem that those values need to be properly tuned.

In view of the above, it is an object of the present invention to provide a model estimation device, a model estimation method, and a model estimation program capable of estimating a model of a neural network by automatically setting the number of layers and the number of nodes without losing theoretical validity.

### Solution to Problem

A model estimation device according to the present invention is a model estimation device that estimates a neural network model, including: a parameter estimation unit that estimates a parameter of a neural network model that maximizes a lower limit of a log marginal likelihood related to observation value data and a node of a hidden layer in the neural network model to be estimated; a variational probability estimation unit that estimates a parameter of a variational probability of the node that maximizes the lower limit of the log marginal likelihood; a node deletion determination unit that determines a node to be deleted on the basis of the variational probability of which the parameter has been estimated, and deletes a node determined to correspond to the node to be deleted; and a convergence determination unit that determines convergence of the neural network model on the basis of a change in the variational probability, in which estimation of the parameter performed by the parameter estimation unit, estimation of the parameter of the variational probability performed by the variational probability estimation unit, and deletion of the node to be deleted performed by the node deletion determination unit are repeated until the convergence determination unit determines that the neural network model has converged.

A model estimation method according to the present invention is a model estimation method for estimating a neural network model, including: estimating a parameter of a neural network model that maximizes a lower limit of a log marginal likelihood related to observation value data and a node of a hidden layer in the neural network model to be estimated; estimating a parameter of a variational probability of the node that maximizes the lower limit of the log marginal likelihood; determining a node to be deleted on the basis of the variational probability of which the parameter has been estimated, and deleting a node determined to correspond to the node to be deleted; and determining convergence of the neural network model on the basis of a change in the variational probability, in which estimation of the parameter, estimation of the parameter of the variational probability, and deletion of the node to be deleted are repeated until the neural network model is determined to have converged.

A model estimation program according to the present invention is a model estimation program to be applied to a computer that estimates a neural network model, which causes the computer to perform: parameter estimation processing that estimates a parameter of a neural network model that maximizes a lower limit of a log marginal likelihood related to observation value data and a node of a hidden layer in the neural network model to be estimated; variational probability estimation processing that estimates a parameter of a variational probability of the node that maximizes the lower limit of the log marginal likelihood; node deletion determination processing that determines a node to be deleted on the basis of the variational probability of which the parameter has been estimated, and deletes a node determined to correspond to the node to be deleted; and convergence determination processing that determines convergence of the neural network model on the basis of a change in the variational probability, in which the parameter estimation processing, the variational probability estimation processing, and the node deletion determination processing are repeated until the neural network model is determined to have converged in the convergence determination processing.

### Advantageous Effects of Invention

According to the present invention, the model of the neural network can be estimated by automatically setting the number of layers and the number of nodes without losing the theoretical validity.

### BRIEF DESCRIPTION OF DRAWINGS

FIG. 1 It depicts a block diagram illustrating a model estimation device according to an exemplary embodiment of the present invention.

FIG. 2 It depicts a flowchart illustrating exemplary operation of the model estimation device.

FIG. 3 It depicts a block diagram illustrating an outline of the model estimation device according to the present invention.

FIG. 4 It depicts a schematic block diagram illustrating a configuration of a computer according to at least one exemplary embodiment.

FIG. 5 It depicts an explanatory diagram illustrating a model of a neural network.

### DESCRIPTION OF EMBODIMENTS

Hereinafter, exemplary embodiments of the present invention will be described with reference to the accompanying drawings.

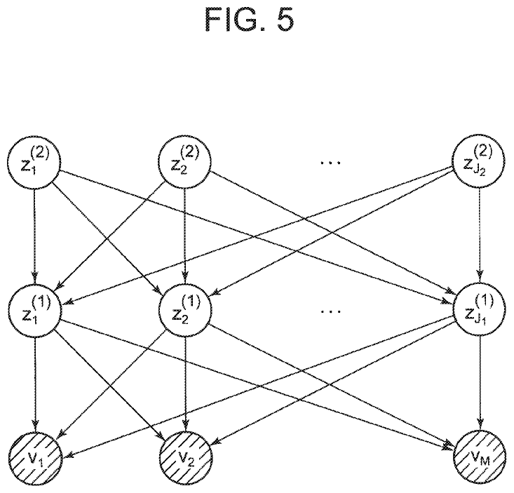

Hereinafter, contents of the present invention will be described with reference to a neural network exemplified in FIG. 5 as appropriate. In the case of a sigmoid belief network (SBN) having visible elements of the number of M and elements of the number of J₁ (l is the 1-th hidden layer) as exemplified in FIG. 5, probabilistic relationships between different layers can be expressed by formulae 1 to 3 exemplified below.

$$\begin{matrix} [ Math . 1 ] & \\ p ( {z}^{( L )} \vert b ) = {\prod }_{i = 1}^{{J}_{L}} {{[ σ ( {b}_{i} ) ]}^{{z}_{i}^{( L )}} [ σ ( - {b}_{i} ) ]}^{1 - {z}_{i}^{( L )}} & ( Formula 1 ) \\ \begin{matrix}p ( {z}^{( l )} \vert {z}^{( i + 1 )} ) = {\prod }_{i = 1}^{{J}_{L}} {[ σ ( {W}_{i}^{( i + 1 )} {z}^{( i + 1 )} + {c}_{i}^{( i + 1 )} ) ]}^{{z}_{i}^{( l )}} \\ {[ σ ( - ( {W}_{i}^{( l + 1 )} {z}^{( l + 1 )} + {c}_{i}^{( l + 1 )} ) ) ]}^{1 - {z}_{i}^{( l )}}\end{matrix} & ( Formula 2 ) \\ p ( v \vert {z}^{( 1 )} ) = {\prod }_{i = 1}^{M} {{[ σ ( {W}_{i}^{( 1 )} {z}^{( 1 )} + {c}_{i}^{( 1 )} ) ]}^{{v}_{i}} [ σ ( - ( {W}_{i}^{( 1 )} {z}^{( 1 )} + {c}_{i}^{( 1 )} ) ) ]}^{r} & ( Formula 3 )\end{matrix}$$

In the formulae 1 to 3, σ(x)=1/1+exp(−x) represents a sigmoid function. Besides, zᵢ⁽¹⁾ represents the i-th binary element in the 1-th hidden layer, and zᵢ⁽¹⁾∈{0, 1}. Besides, vᵢ is the i-th input in a visible layer, which is expressed as follows.

vᵢ∈ [symbol] ⁺∪{0} [Math. 2]

Besides, W⁽¹⁾ represents a weight matrix between an 1 layer and an l−1 layer, which is expressed as follows.

W^{(l)}∈ [symbol] ^{J}^{_{(l−1)}}^{×J}^{ₗ}, ∀l=1, . . . , L [Math. 3]

Note that, in order to simplify the notation, it is represented by M=J₀ in the following descriptions. Besides, b is the bias of the uppermost layer, which is expressed as follows.

b∈ [symbol] ^{J}^{_{L}} [Math. 4]

Besides, c⁽¹⁾ corresponds to the bias in the remaining layers, which is expressed as follows.

c^{(l)}∈ [symbol] ^{J}^{ₗ}, ∀l=0, . . . , L−1 [Math. 5]

In the present exemplary embodiment, factorized asymptotic Bayesian (FAB) inference is applied to the model selection problem in the SBN, and the number of hidden elements in the SBN is automatically determined. The FAB inference solves the model selection problem by maximizing the lower limit of a factorized information criterion (FIC) derived on the basis of Laplace approximation of simultaneous likelihood.

First of all, for a given model M, log-likelihood of v and z is expressed by the following formula 4. In the formula 4, it is expressed as θ={W, b, c}.

$$\begin{matrix}[ Math . 6 ] & \\ \begin{matrix}log p ( v , z \vert M ) = log \int p ( v , z \vert θ ) p ( θ \vert ℳ ) d θ \\ = {\sum }_{m} log \int p ( {v}_{\cdot m} , {z}_{\cdot m} \vert θ ) p ( θ \vert M ) d θ\end{matrix} & ( Formula 4 )\end{matrix}$$

Here, although a single-layered hidden layer is assumed for ease of explanation, it can be easily expanded also in the case of multiple layers. With the Laplace method being applied to the formula 4 mentioned above, an approximation formula exemplified in the following formula 5 is derived.

$$\begin{matrix} [ Math . 7 ] & \\ log p ( v , z \vert M ) \approx \frac{{D}_{θ}}{2} log ( \frac{2 π}{N} ) + log p ( v , z \vert \hat{θ} ) + log p ( \hat{θ} \vert ℳ ) - \frac{1}{2} {\sum }_{j} log \frac{{\partial }^{2}}{\partial {b}_{j}^{2}} [ - log p ( z \cdot j \vert {b}_{j} ) ] - \frac{1}{2} {\sum }_{m} log \vert {Ψ}_{m} \vert & ( Formula 5 )\end{matrix}$$

In the formula 5, D_{θ} represents the dimension of θ, and θ\hat{ } represents a maximum-likelihood (ML) evaluation of θ. In addition, Ψₘ represents a second derivative matrix of log-likelihood with respect to Wᵢ and cᵢ.

According to the following Reference Literatures 1 and 2, since the constant term can be asymptotically ignored in the formula 5 mentioned above, log Ψₘ can be approximated as the following formula 6. Reference Literature 1 described below is referenced and cited herein.

### <Reference Literature 1>

International Publication No. 2014/188659

### <Reference Literature 2>

Japanese Translation of PCT International Publication No. 2016-520220

$$\begin{matrix}[ Math . 8 ] & \\ log \vert {Ψ}_{m} \vert \approx {\sum }_{j} log \frac{{\sum }_{n} {z}_{nj}}{N} & ( Formula 6 )\end{matrix}$$

On the basis of these, the FIC in the SBN can be defined as the following formula 7.

$$\begin{matrix} [ Math . 9 ] & \\ FIC ( J ) = {max}_{q} {𝔼}_{q} [ ℒ ( z , \hat{θ} , J ) ] + H ( q ) + ( 1 ) & ( Formula 7 ) \\ where , & \\ ℒ ( z , θ , J ) = ln p ( v , z \vert θ , J ) - \frac{1}{2} {\sum }_{j} ln {\sum }_{n} {z}_{nj} - \frac{{D}_{θ} - MJ}{2} ln N & \end{matrix}$$

From concavity of a log function, the lower limit of the FIC in the formula 7 can be obtained by the following formula 8.

$$\begin{matrix} [ Math . 10 ] & \\ FIC ( J ) \geq {𝔼}_{q} [ ln p ( v , z \vert θ , J ) ] - \frac{1}{2} {\sum }_{j} {ln \sum }_{n} {𝔼}_{q} [ {z}_{nj} ] - \frac{{D}_{θ} - MJ}{2} ln N + H ( q ) & ( Formula 8 )\end{matrix}$$

Examples of a method of estimating a model parameter and selecting a model after derivation of the FIC include a method of using the mean-field variational Bayesian (VB). However, since the mean-field VB is supposed to be independent between the hidden variables, it cannot be used for the SBN. In view of the above, in the VB, probabilistic optimization in which variational objects difficult to handle are approximated using the Monte Carlo sample and dispersion in gradients with noise is reduced is used.

On the assumption of variation distribution, a variational probability q in the formula 7 mentioned above can be simulated as the following formula 9 using a recognition network that maps v to z by the neural variational inference and learning (NVIL) algorithm. Note that, in order to simplify the notation, it is assumed to be v=z⁽⁰⁾ and J₀=M. The NVIL algorithm is disclosed in, for example, the following Reference Literature 3.

### <Reference Literature 3>

Mnih, A. and Gregor, K., “Neural variational inference and learning in belief networks”, ICML, JMLR: W&CP vol. 32, pp. 1791-1799, 2014

$$\begin{matrix} [ Math . 11 ] & \\ q ( {z}^{( l )} \vert {z}^{( l - 1 ) . {φ}^{( l )}} ) = {\prod }_{i = 1}^{{J}_{t}} {{[ σ ( {φ}_{i}^{( l )} {z}^{( l - 1 )} ) ]}^{{z}_{i}^{( l )}} [ σ ( - {φ}_{i}^{( l )} {z}^{( l - 1 )} ) ]}^{1 - {z}_{i}^{( l )}} & ( Formula 9 )\end{matrix}$$

In the formula 9, φ⁽¹⁾ is a weight matrix of the recognition network in the 1 layer, which has the following property.

ϕ^{(l)}∈ [symbol] ^{J}^{ₗ}^{×J}^{_{l−1}} [Math. 12]

In order to learn the model and the recognition network generated in the SBN, the stochastic gradient ascent method is normally used. From the parametric equation of the recognition model in the formulae 8 and 9 mentioned above, the objective function f can be expressed as the following formula 10.

$$\begin{matrix} [ Math . 13 ] & \\ f = {𝔼}_{q} [ ln p ( v , z \vert θ , J ) ] - \frac{1}{2} {\sum }_{j} ln {\sum }_{n} σ ( {φ}_{j} \cdot {v}_{n}^{T} . ) + H ( q ) & ( Formula 10 )\end{matrix}$$

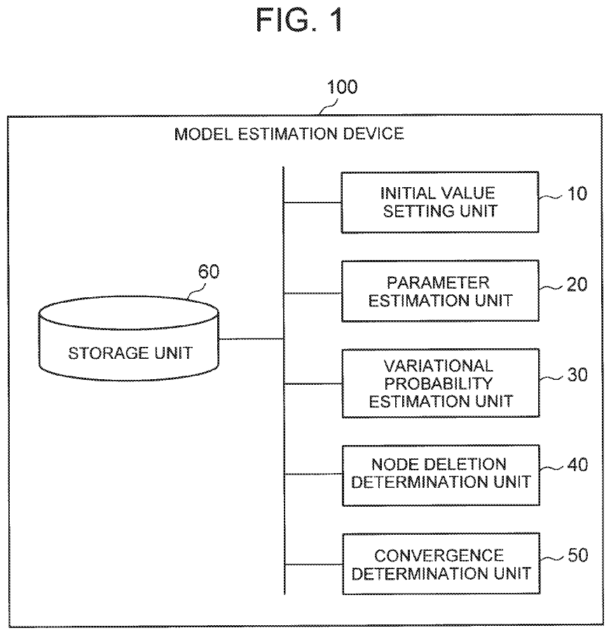

On the basis of the above, processing of the model estimation device according to the present invention will be described. FIG. 1 is a block diagram illustrating a model estimation device according to an exemplary embodiment of the present invention. A model estimation device 100 according to the present exemplary embodiment includes an initial value setting unit 10, a parameter estimation unit 20, a variational probability estimation unit 30, a node deletion determination unit 40, a convergence determination unit 50, and a storage unit 60.

The initial value setting unit 10 initializes various parameters used for estimating a model of a neural network. Specifically, the initial value setting unit 10 inputs observation value data, the number of initial nodes, and the number of initial layers, and outputs a variational probability and a parameter. The initial value setting unit 10 stores the set variational probability and the parameter in the storage unit 60.

The parameter output here is a parameter used in a neural network model. The neural network model expresses how the probability of the observation value v is determined, and the parameter of the model is used to express interaction between layers or a relationship between an observation value layer and a hidden variable layer.

The formulae 1 to 3 mentioned above expresses the neural network model. In the case of the formulae 1 to 3, b (concretely, W, c, and b) is a parameter. In addition, in the case of the formulae 1 to 3, the observation value data corresponds to v, the number of initial nodes corresponds to the initial value of J₁, and the number of initial layers corresponds to L. The initial value setting unit 10 sets a relatively large value to those initial values. Thereafter, processing for gradually decreasing the number of initial nodes and the number of initial layers is performed.

Further, in the present exemplary embodiment, when the neural network model is estimated, estimation of the parameter mentioned above and estimation of the probability that the hidden variable node is one are repeated. The variational probability represents the above-mentioned probability that the hidden variable node is one, which can be expressed by the formula 9 mentioned above, for example. In the case where the variational probability is expressed by the formula 9, the initial value setting unit 10 outputs a result of initializing the parameter φ of distribution of q.

The parameter estimation unit 20 estimates the parameter of the neural network model. Specifically, the parameter estimation unit 20 obtains, on the basis of the observation value data, the parameter, and the variational probability, the parameter of the neural network model that maximizes the lower limit of the log marginal likelihood. The parameter used for determining the parameter of the neural network model is a parameter of the neural network model initialized by the initial value setting unit 10, or a parameter of the neural network model updated by the processing to be described later. The formula for maximizing the lower limit of the marginalization likelihood is expressed by the formula 8 in the example above. Although there are several sets for maximizing the lower limit of the marginalization likelihood with respect to a parameter W of the neural network model concerning the formula 8, the parameter estimation unit 20 may obtain the parameter using the gradient method, for example.

In the case of using the gradient method, the parameter estimation unit 20 calculates the gradient of the i-th row with respect to the weight matrix of the 1-th level (i.e., W⁽¹⁾) of the generated model by the following formula 11.

$$\begin{matrix}[ Math . 14 ] & \\ \begin{matrix}\frac{\partial }{\partial {W}_{i}^{( l )}} f = {𝔼}_{q} [ \frac{\partial }{\partial {W}_{i}^{( l )}} ln p ( v , z \vert θ , J ) ] \\ = {𝔼}_{q} \{ \frac{1}{N} {\sum }_{n = 1}^{N} [ {z}_{n , i}^{( l - 1 )} - σ ( {W}_{i}^{( l )} {z}_{n}^{( l )} ) ] {z}_{n}^{( l )} \}\end{matrix} & ( Formula 11 )\end{matrix}$$

Since the expectation value in the formula 11 is difficult to evaluate, the parameter estimation unit 20 uses the Monte Carlo integration using the sample generated from the variation distribution to approximate the expectation value.

The parameter estimation unit 20 updates the original parameter using the obtained parameter. Specifically, the parameter estimation unit 20 updates the parameter stored in the storage unit 60 with the obtained parameter. In the case of the above example, the parameter estimation unit 20 calculates the gradient, and then updates the parameter using the standard gradient ascent algorithm. For example, the parameter estimation unit 20 updates the parameter on the basis of the following formula 12. Note that τ_{W} is a learning coefficient of the model to be generated.

$$\begin{matrix}[ Math . 15 ] & \\ {W}_{i}^{( l )} ← {W}_{i}^{( l )} + τ w \frac{\partial }{\partial {w}_{i}^{( l )}} f & ( Formula 12 )\end{matrix}$$

The variational probability estimation unit 30 estimates the parameter of the variational probability. Specifically, the variational probability estimation unit 30 estimates, on the basis of the observation value data, the parameter, and the variational probability, the parameter of the variational probability that maximizes the lower limit of the log marginal likelihood. The parameter used for determining the parameter of the variational probability is a parameter of the variational probability initialized by the initial value setting unit 10 or a parameter of the variational probability updated by the processing to be described later, and a parameter of the neural network model.

In a similar manner to the contents described in the parameter estimation unit 20, the formula for maximizing the lower limit of the marginalization likelihood is expressed by the formula 8 in the example above. In a similar manner to the parameter estimation unit 20, the variational probability estimation unit 30 may estimate the parameter of the variational probability using the gradient method to maximize the lower limit of the marginalization likelihood with respect to the parameter φ of the variational probability.

In the case of using the gradient method, the variational probability estimation unit 30 calculates the gradient of the i-th row with respect to the weight matrix of the l-th level (i.e., φᵢ^{(l)}) of the recognition network by the following formula 13.

$$\begin{matrix} [ Math . 16 ] \\ ( Formula 13 ) & \\ \begin{matrix}\frac{\partial }{\partial {φ}_{i}^{( l )}} f = \frac{\partial }{\partial {φ}_{i}^{( l )}} {𝔼}_{q} [ ln p ( v , z \vert θ , J ) + H ( q ) ] - \frac{M}{2} \frac{\partial }{\partial {φ}_{i}^{( l )}} ln {\sum }_{n} σ [ {{φ}_{i}^{( l )} ( {z}_{n}^{( i - 1 )} )}^{T} ] \\ = \frac{\partial }{\partial {φ}_{i}^{( l )}} \frac{1}{N} {\sum }_{n = 1}^{N} {\sum }_{{z}_{n}^{( l )}}^{ } q ( {z}_{n}^{( l )} \vert {z}_{n}^{( l - 1 )} , {φ}^{( l )} ) ln p ( {z}_{n}^{( l - 1 )} , {z}_{n}^{( l )} \vert θ ) - \\ \frac{\partial }{\partial {φ}_{i}^{( l )}} \frac{1}{N} {\sum }_{n = 1}^{N} {\sum }_{{z}_{n}^{( l )}}^{ } q ( {z}_{n}^{( l )} \vert {z}_{n}^{( l - 1 )} , {φ}^{( l )} ) ln q ( {z}_{n}^{( l - 1 )} , {φ}^{( l )} ) - \\ \frac{1}{2} \frac{{\sum }_{n} \{ σ \vert {{φ}_{i}^{( l )} ( {z}_{n}^{( l - 1 )} )}^{T} ] σ [ - {{φ}_{i}^{( l )} ( {z}_{n}^{( l - 1 )} )}^{T} ] {( {z}_{n}^{( l - 1 )} )}^{T}}{{\sum }_{n} σ [ {{φ}_{i}^{( l )} ( {z}_{n}^{( l - 1 )} )}^{T} ]} \\ = {𝔼}_{q} \{ \frac{1}{N} {\sum }_{n = 1}^{N} [ ln p ( {z}_{n}^{( l - 1 )} , {z}_{n , i}^{( l )} \vert θ ) - ln q ( {z}_{n , i}^{( l )} \vert {z}_{n}^{( l - 1 )} , {φ}_{i}^{( l )} ) ] \\ {[ {z}_{n , i}^{( l )} - σ ( {φ}_{i}^{( l )} {z}_{n}^{( l - 1 )} ) ] [ {z}_{n}^{( l - 1 )} ]}^{T} - \\ \frac{1}{2} \frac{{\sum }_{n} \{ σ [ {{φ}_{i}^{( l )} ( {z}_{n}^{( l - 1 )} )}^{T} ] σ [ - {{φ}_{i}^{( l )} ( {z}_{n}^{( l - 1 )} )}^{T} ] {( {z}_{n}^{( l - 1 )} )}^{T} \}}{{\sum }_{n} σ [ {{φ}_{i}^{( l )} ( {z}_{n}^{( l - 1 )} )}^{T} ]} \}\end{matrix} & \end{matrix} \qquad$$

Since the expectation value in the formula 13 is difficult to evaluate in a similar manner to the expectation value in the formula 11, the variational probability estimation unit 30 uses the Monte Carlo integration using the sample generated from the variation distribution to approximate the expectation value.

The variational probability estimation unit 30 updates the parameter of the original variational probability using the estimated parameter of the variational probability. Specifically, the variational probability estimation unit 30 updates the parameter of the variational probability stored in the storage unit 60 with the obtained parameter of the variational probability. In the case of the above example, the variational probability estimation unit 30 calculates the gradient, and then updates the parameter of the variational probability using the standard gradient ascent algorithm. For example, the variational probability estimation unit 30 updates the parameter on the basis of the following formula 14. Note that τ_{φ} is a learning coefficient of the recognition network.

$$\begin{matrix}[ Math . 17 ] & \\ {φ}_{i}^{( l )} ← {φ}_{i}^{( l )} + τφ \frac{\partial }{\partial {φ}_{i}^{( l )}} f & ( Formula 14 )\end{matrix}$$

The node deletion determination unit 40 determines whether to delete the node of the neural network model on the basis of the variational probability of which the parameter has been estimated by the variational probability estimation unit 30. Specifically, when the sum of the variational probabilities calculated for the nodes of each layer is equal to or less than a threshold value, the node deletion determination unit 40 determines that it is a node to be deleted, and deletes the node. A formula for determining whether the k-th node of the 1 layer is a node to be deleted is expressed by the following formula 15, for example.

$$\begin{matrix}[ Math . 18 ] & \\ \frac{{\sum }_{n} {𝔼}_{q} [ {z}_{nk}^{( l )} ]}{N} \leq ϵ & ( Formula 15 )\end{matrix}$$

In this manner, the node deletion determination unit 40 determines whether to delete the node on the basis of the estimated variational probability, whereby a compact neural network model with a small calculation load can be estimated.

The convergence determination unit 50 determines the convergence of the neural network model on the basis of the change in the variational probability. Specifically, the convergence determination unit 50 determines whether the obtained parameter and the estimated variational probability satisfy the optimization criterion.

Each parameter is updated by the parameter estimation unit 20 and the variational probability estimation unit 30. Therefore, for example, when an update width of the variational probability is smaller than the threshold value or the change in the lower limit value of the log marginal likelihood is small, the convergence determination unit 50 determines that the estimation processing of the model has converged, and the process is terminated. On the other hand, when it is determined that the convergence is not complete, the processing of the parameter estimation unit 20 and the processing of the variational probability estimation unit 30 are performed, and the series of processing up to the node deletion determination unit 40 is repeated. The optimization criterion is determined in advance by a user or the like, and is stored in the storage unit 60.

The initial value setting unit 10, the parameter estimation unit 20, the variational probability estimation unit 30, the node deletion determination unit 40, and the convergence determination unit 50 are implemented by a CPU of a computer operating according to a program (model estimation program). For example, the program is stored in the storage unit 60, and the CPU may read the program to operate as the initial value setting unit 10, the parameter estimation unit 20, the variational probability estimation unit 30, the node deletion determination unit 40, and the convergence determination unit 50 according to the program.

Further, each of the initial value setting unit 10, the parameter estimation unit 20, the variational probability estimation unit 30, the node deletion determination unit 40, and the convergence determination unit 50 may be implemented by dedicated hardware. Furthermore, the storage unit 60 is implemented by, for example, a magnetic disk or the like.

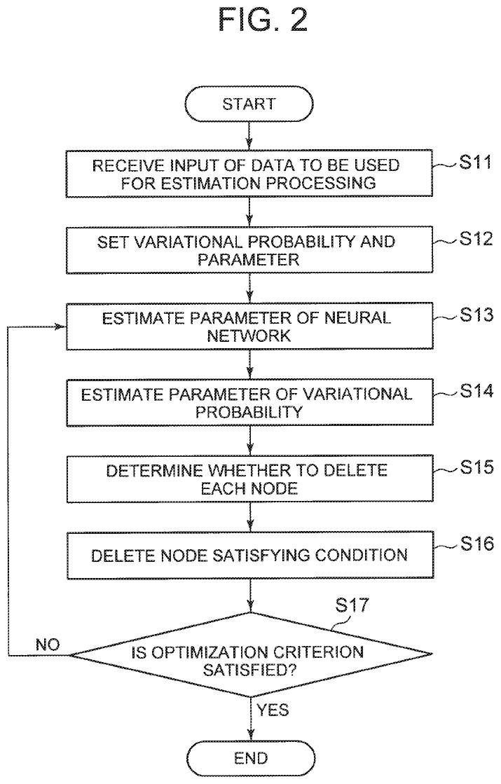

Next, operation of the model estimation device according to the present exemplary embodiment will be described. FIG. 2 is a flowchart illustrating exemplary operation of the model estimation device according to the present exemplary embodiment.

The model estimation device 100 receives input of the observation value data, the number of initial nodes, the number of initial layers, and the optimization criterion as data used for the estimation processing (step S11). The initial value setting unit 10 sets variational probability and a parameter on the basis of the input observation value data, the number of initial nodes, and the number of initial layers (step S12).

The parameter estimation unit 20 estimates a parameter of the neural network that maximizes the lower limit of the log marginal likelihood on the basis of the observation value data, and the set parameter and the variational probability (step S13). Further, the variational probability estimation unit 30 estimates a parameter of the variational probability to maximize the lower limit of the log marginal likelihood on the basis of the observation value data, and the set parameter and the variational probability (step S14).

The node deletion determination unit 40 determines whether to delete each node from the model on the basis of the estimated variational probability (step S15), and deletes the node that satisfies (corresponds to) a predetermined condition (step S16).

The convergence determination unit 50 determines whether the obtained parameter and the estimated variational probability satisfy the optimization criterion (step S17). When it is determined that the optimization criterion is satisfied (Yes in step S17), the process is terminated. On the other hand, when it is determined that the optimization criterion is not satisfied (No in step S17), the process is repeated from step S13.

In FIG. 2, operation in which the processing of the parameter estimation unit 20 is performed after the processing of the initial value setting unit 10, and then the processing of the variational probability estimation unit 30 and the processing of the node deletion determination unit 40 are performed is exemplified. However, the order of the processing is not limited to the method exemplified in FIG. 2. The processing of the variational probability estimation unit 30 and the processing of the node deletion determination unit 40 may be performed after the processing of the initial value setting unit 10, and then the processing of the parameter estimation unit 20 may be performed. In other words, the processing of steps S14 and S15 may be performed after the processing of step S12, and then the processing of step S12 may be performed. Then, when it is determined that the optimization criterion is not satisfied in the processing of step S15, the process may be repeated from step S14.

As described above, in the present exemplary embodiment, the parameter estimation unit 20 estimates the parameter of the neural network model that maximizes the lower limit of the log marginal likelihood related to v and z, and the variational probability estimation unit 30 also estimates the parameter of the variational probability of the node that maximizes the lower limit of the log marginal likelihood. The node deletion determination unit 40 determines a node to be deleted on the basis of the estimated variational probability, and deletes the node determined to be deleted. The convergence determination unit 50 determines the convergence of the neural network model on the basis of the change in the variational probability.

Then, until the convergence determination unit 50 determines that the neural network model has converged, the estimation processing of the parameter of the neural network, the estimation processing of the parameter of the variational probability, and the deletion processing of the corresponding node are repeated. Therefore, the model of the neural network can be estimated by automatically setting the number of layers and the number of nodes without losing the theoretical validity.

It is also possible to generate a model that increases the number of layers to prevent overlearning. However, in a case where such a model is generated, it takes time to calculate and the like, and much memory is required. In the present exemplary embodiment, the model is estimated such that the number of layers is reduced, whereby a model with a small calculation load can be estimated while overlearning is prevented.

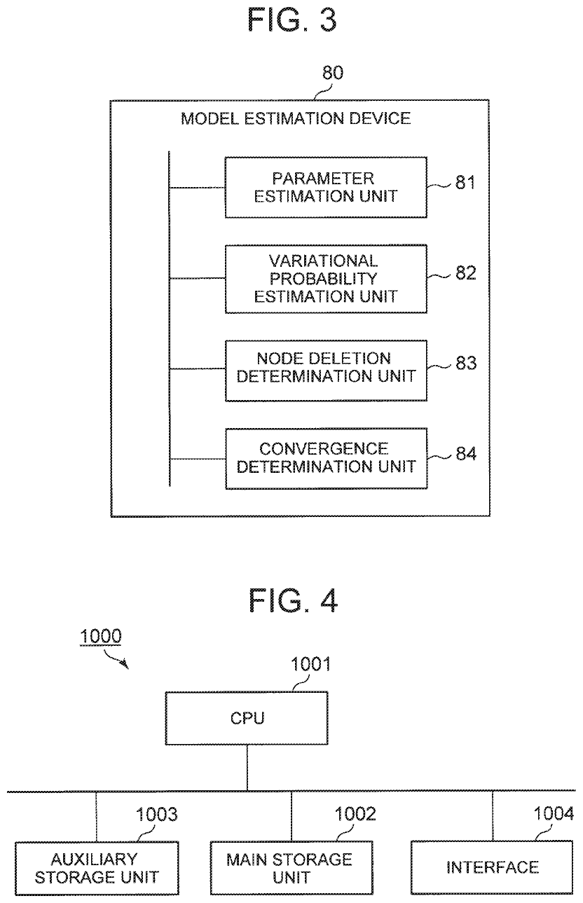

Next, an outline of the present invention will be described. FIG. 3 is a block diagram illustrating the outline of the model estimation device according to the present invention. The model estimation device according to the present invention is a model estimation device 80 (e.g., model estimation device 100) that estimates a neural network model, which includes a parameter estimation unit 81 (e.g., parameter estimation unit 20), a variational probability estimation unit 82 (e.g., variational probability estimation unit 30), a node deletion determination unit 83 (e.g., node deletion determination unit 40), and a convergence determination unit 84 (e.g., convergence determination unit 50). The parameter estimation unit 81 estimates a parameter (e.g., θ in the formula 8) of the neural network model that maximizes the lower limit of the log marginal likelihood related to observation value data (e.g., visible element v) and a hidden layer node (e.g., node z) in the neural network model to be estimated (e.g., M). The variational probability estimation unit 82 estimates a parameter (e.g., φ in the formula 9) of the variational probability of the node that maximizes the lower limit of the log marginal likelihood. The node deletion determination unit 83 determines a node to be deleted on the basis of the variational probability of which the parameter has been estimated, and deletes the node determined to be the node to be deleted. The convergence determination unit 84 determines the convergence of the neural network model on the basis of the change in the variational probability (e.g., optimization criterion).

Until the convergence determination unit 84 determines that the neural network model has converged, estimation of the parameter performed by the parameter estimation unit 81, estimation of the parameter of the variational probability performed by the variational probability estimation unit 82, and deletion of the corresponding node performed by the node deletion determination unit 83 are repeated.

With such a configuration, the model of the neural network can be estimated by automatically setting the number of layers and the number of nodes without losing the theoretical validity.

The node deletion determination unit 83 may determine a node in which the sum of the variational probabilities is equal to or less than a predetermined threshold value to be a node to be deleted.

In addition, the parameter estimation unit 81 may estimate, on the basis of the observation value data, the parameter, and the variational probability, the parameter of the neural network model that maximizes the lower limit of the log marginal likelihood. The parameter estimation unit 81 may then update the original parameter with the estimated parameter.

In addition, the variational probability estimation unit 82 may estimate, on the basis of the observation value data, the parameter, and the variational probability, the parameter of the variational probability that maximizes the lower limit of the log marginal likelihood. The variational probability estimation unit 82 may then update the original parameter with the estimated parameter.

Specifically, the parameter estimation unit 81 may approximate the log marginal likelihood on the basis of the Laplace method to estimate a parameter that maximizes the lower limit of the approximated log marginal likelihood. The variational probability estimation unit 82 may then estimate, on the assumption of variation distribution, a parameter of the variational probability to maximize the lower limit of the log marginal likelihood.

FIG. 4 is a schematic block diagram illustrating a configuration of a computer according to at least one exemplary embodiment. A computer 1000 includes a CPU 1001, a main storage unit 1002, an auxiliary storage unit 1003, and an interface 1004.

The model estimation device described above is mounted on the computer 1000. Operation of each of the processing units described above is stored in the auxiliary storage unit 1003 in the form of a program (model estimation program). The CPU 1001 reads the program from the auxiliary storage unit 1003, loads it into the main storage unit 1002, and executes the processing described above according to the program.

Note that the auxiliary storage unit 1003 is an example of a non-transitory concrete medium in at least one exemplary embodiment. Other examples of the non-transitory concrete medium include a magnetic disk, a magneto-optical disk, a CD-ROM, a DVD-ROM, and a semiconductor memory connected via the interface 1004. In a case where this program is delivered to the computer 1000 through a communication line, the computer 1000 that has received the delivery may load the program into the main storage unit 1002 to execute the processing described above.

Further, the program may be for implementing a part of the functions described above. Furthermore, the program may be a program that implements the function described above in combination with another program already stored in the auxiliary storage unit 1003, which is what is called a differential file (differential program).

A part of or all of the exemplary embodiments described above may also be described as in the following Supplementary notes, but is not limited thereto.

(Supplementary note 1) A model estimation device that estimates a neural network model, including: a parameter estimation unit that estimates a parameter of a neural network model that maximizes a lower limit of a log marginal likelihood related to observation value data and a node of a hidden layer in the neural network model to be estimated; a variational probability estimation unit that estimates a parameter of a variational probability of the node that maximizes the lower limit of the log marginal likelihood; a node deletion determination unit that determines a node to be deleted on the basis of the variational probability of which the parameter has been estimated, and deletes a node determined to correspond to the node to be deleted; and a convergence determination unit that determines convergence of the neural network model on the basis of a change in the variational probability, in which estimation of the parameter performed by the parameter estimation unit, estimation of the parameter of the variational probability performed by the variational probability estimation unit, and deletion of the node to be deleted performed by the node deletion determination unit are repeated until the convergence determination unit determines that the neural network model has converged.

(Supplementary note 2) The model estimation device according to Supplementary note 1, in which the node deletion determination unit determines a node in which the sum of variational probabilities is equal to or less than a predetermined threshold value to be the node to be deleted.

(Supplementary note 3) The model estimation device according to Supplementary note 1 or 2, in which the parameter estimation unit estimates the parameter of the neural network model that maximizes the lower limit of the log marginal likelihood on the basis of observation value data, a parameter, and a variational probability.

(Supplementary note 4) The model estimation device according to Supplementary note 3, in which the parameter estimation unit updates an original parameter using the estimated parameter.

(Supplementary note 5) The model estimation device according to any one of Supplementary notes 1 to 4, in which the variational probability estimation unit estimates the parameter of the variational probability that maximizes the lower limit of the log marginal likelihood on the basis of observation value data, a parameter, and a variational probability.

(Supplementary note 6) The model estimation device according to Supplementary note 5, in which the variational probability estimation unit updates an original parameter using the estimated parameter.

(Supplementary note 7) The model estimation device according to any one of Supplementary notes 1 to 6, in which the parameter estimation unit approximates the log marginal likelihood on the basis of a Laplace method, and estimates a parameter that maximizes the lower limit of the approximated log marginal likelihood, and the variational probability estimation unit estimates a parameter of the variational probability such that the lower limit of the log marginal likelihood is maximized on the assumption of variation distribution.

(Supplementary note 8) A model estimation method for estimating a neural network model, including: estimating a parameter of a neural network model that maximizes a lower limit of a log marginal likelihood related to observation value data and a node of a hidden layer in the neural network model to be estimated; estimating a parameter of a variational probability of the node that maximizes the lower limit of the log marginal likelihood; determining a node to be deleted on the basis of the variational probability of which the parameter has been estimated, and deleting a node determined to correspond to the node to be deleted; and determining convergence of the neural network model on the basis of a change in the variational probability, in which estimation of the parameter, estimation of the parameter of the variational probability, and deletion of the node to be deleted are repeated until the neural network model is determined to have converged.

(Supplementary note 9) The model estimation method according to Supplementary note 8, in which a node in which the sum of variational probabilities is equal to or less than a predetermined threshold value is determined to be the node to be deleted.

(Supplementary note 10) A model estimation program to be applied to a computer that estimates a neural network model, which causes the computer to perform: parameter estimation processing that estimates a parameter of a neural network model that maximizes a lower limit of a log marginal likelihood related to observation value data and a node of a hidden layer in the neural network model to be estimated; variational probability estimation processing that estimates a parameter of a variational probability of the node that maximizes the lower limit of the log marginal likelihood; node deletion determination processing that determines a node to be deleted on the basis of the variational probability of which the parameter has been estimated, and deletes a node determined to correspond to the node to be deleted; and convergence determination processing that determines convergence of the neural network model on the basis of a change in the variational probability, in which the parameter estimation processing, the variational probability estimation processing, and the node deletion determination processing are repeated until the neural network model is determined to have converged in the convergence determination processing.

(Supplementary note 11) The model estimation program according to Supplementary note 10, which causes the computer to determine a node in which the sum of variational probabilities is equal to or less than a predetermined threshold value to be the node to be deleted in the node deletion determination processing.

Although the present invention has been described with reference to the exemplary embodiments and the examples, the present invention is not limited to the exemplary embodiments and the examples described above. Various modifications that can be understood by those skilled in the art within the scope of the present invention can be made in the configuration and details of the present invention.

This application claims priority based on Japanese Patent Application No. 2016-199103 filed on Oct. 7, 2016, the disclosure of which is incorporated herein in its entirety.

### INDUSTRIAL APPLICABILITY

The present invention is suitably applied to a model estimation device that estimates a model of a neural network. For example, it is possible to generate a neural network model that performs image recognition, text classification, and the like using the model estimation device according to the present invention.

### REFERENCE SIGNS LIST

10 Initial value setting unit
20 Parameter estimation unit
30 Variational probability estimation unit
40 Node deletion determination unit
50 Convergence determination unit
100 Model estimation device

1. A model estimation device that estimates a neural network model, the model estimation device comprising:
a hardware including a processor;
a parameter estimation unit, implemented by the processor, that estimates a parameter of a neural network model that maximizes a lower limit of a log marginal likelihood related to observation value data and a node of a hidden layer in the neural network model to be estimated;
a variational probability estimation unit, implemented by the processor, that estimates a parameter of a variational probability of the node that maximizes the lower limit of the log marginal likelihood;
a node deletion determination unit, implemented by the processor, that determines a node to be deleted on the basis of the variational probability of which the parameter has been estimated, and deletes a node determined to correspond to the node to be deleted; and
a convergence determination unit, implemented by the processor, that determines convergence of the neural network model on the basis of a change in the variational probability, wherein
estimation of the parameter performed by the parameter estimation unit, estimation of the parameter of the variational probability performed by the variational probability estimation unit, and deletion of the node to be deleted performed by the node deletion determination unit are repeated until the convergence determination unit determines that the neural network model has converged.

2. The model estimation device according to claim 1, wherein
the node deletion determination unit determines a node in which the sum of variational probabilities is equal to or less than a predetermined threshold value to be the node to be deleted.

3. The model estimation device according to claim 1, wherein
the parameter estimation unit estimates the parameter of the neural network model that maximizes the lower limit of the log marginal likelihood on the basis of observation value data, a parameter, and a variational probability.

4. The model estimation device according to claim 3, wherein
the parameter estimation unit updates an original parameter using the estimated parameter.

5. The model estimation device according to claim 1, wherein
the variational probability estimation unit estimates the parameter of the variational probability that maximizes the lower limit of the log marginal likelihood on the basis of observation value data, a parameter, and a variational probability.

6. The model estimation device according to claim 5, wherein
the variational probability estimation unit updates an original parameter using the estimated parameter.

7. The model estimation device according to claim 1, wherein
the parameter estimation unit approximates the log marginal likelihood on the basis of a Laplace method, and estimates a parameter that maximizes the lower limit of the approximated log marginal likelihood, and
the variational probability estimation unit estimates a parameter of the variational probability such that the lower limit of the log marginal likelihood is maximized on the assumption of variation distribution.

8. A model estimation method for estimating a neural network model, the model estimation method comprising:
estimating a parameter of a neural network model that maximizes a lower limit of a log marginal likelihood related to observation value data and a node of a hidden layer in the neural network model to be estimated;
estimating a parameter of a variational probability of the node that maximizes the lower limit of the log marginal likelihood;
determining a node to be deleted on the basis of the variational probability of which the parameter has been estimated, and deleting a node determined to correspond to the node to be deleted; and
determining convergence of the neural network model on the basis of a change in the variational probability, wherein
estimation of the parameter, estimation of the parameter of the variational probability, and deletion of the node to be deleted are repeated until the neural network model is determined to have converged.

9. The model estimation method according to claim 8, wherein
a node in which the sum of variational probabilities is equal to or less than a predetermined threshold value is determined to be the node to be deleted.

10. A non-transitory computer readable information recording medium storing a model estimation program to be applied to a computer that estimates a neural network model, when executed by a processor, the model estimation program performs a method for:
estimating a parameter of a neural network model that maximizes a lower limit of a log marginal likelihood related to observation value data and a node of a hidden layer in the neural network model to be estimated;
estimating a parameter of a variational probability of the node that maximizes the lower limit of the log marginal likelihood;
determining a node to be deleted on the basis of the variational probability of which the parameter has been estimated, and deletes a node determined to correspond to the node to be deleted; and
determining convergence of the neural network model on the basis of a change in the variational probability, wherein
estimation of the parameter, estimation of the parameter of the variational probability, and deletion of the node to be deleted are repeated until the neural network model is determined to have converged.

11. The non-transitory computer readable information recording medium according to claim 10, wherein
a node in which the sum of variational probabilities is equal to or less than a predetermined threshold value is determined to be the node to be deleted.
